(19) United States
(12) Patent Application Publication
(10) Pub. No.: US 2023/0248033 A1
(43) Pub. Date: Aug. 10, 2023

(54) FLAVOR MODULATION WITH MALATE SALTS AND FOOD-SAFE ACIDS

(71) Applicant: BARTEK INGREDIENTS, INC., Stoney Creek (CA)

(72) Inventors: Allison Marie VOLL, Wheaton, IL (US); Matthew PATRICK, Cincinnati, OH (US); Michelle FRAME, Chicago, IL (US); Jeffrey L. BILLIG, Lincoln University, PA (US); Mohammad EMAMI, Toronto (CA)

(21) Appl. No.: 18/302,482

(22) Filed: Apr. 18, 2023

Related U.S. Application Data
(63) Continuation-in-part of application No. PCT/CA2022/050953, filed on Jun. 15, 2022.
(60) Provisional application No. 63/210,901, filed on Jun. 15, 2021.

(51) Int. Cl. A23L 27/20; A23L 29/231

(52) U.S. Cl. CPC A23L 27/20; A23L 29/231; A23L 27/2028

(57) ABSTRACT

pH stabilizing agents with partially hydrogenated malic acid salts are provided for use in pH buffering systems. The pH stabilizing agent is typically a food-safe acid and a partially hydrogenated malic acid salt selected from monopotassium malate, monosodium malate, and combinations thereof. These stabilizing agents may be used to augment the flavor profile of a product such as a confectionery. Products comprising these pH stabilizing agents and methods of producing these products with the pH stabilizing agents are provided.

### CROSS REFERENCE TO RELATED APPLICATIONS

The present application is a continuation in part application of PCT/CA2022/050953 filed Jun. 15, 2022 which claims priority to and the benefit of U.S. App. No. 63/210,901, filed Jun. 15, 2021, the entire contents of which are hereby incorporated by reference in their entirety.

### FIELD OF DISCLOSURE

The present invention pertains to specific malate salts as pH-stabilizing agents in compositions and the resultant flavor augmentation possible with these agents in flavored products such as fruit flavored confectionery.

### BACKGROUND

The use of buffers such as sodium citrate are often used in confectionery products. These buffers are used to stabilize the pH of compositions within a range established by the buffer in concert with an acid or base. Buffers are not used to impart or alter the flavor of a product.

Buffers are used in a wide variety of confectioneries such as gummies. Gummy In addition, gummy compositions are also used to prepare dosage forms for delivery of active agents, such as nutraceutical agents or pharmaceutical agents. Gummy dosage forms enable compliant dosing in members of the population including children, geriatric adults, and others who are unable to swallow pills and thus require chewable dosage forms. Others may prefer gummy dosage forms for the convenience of having a chewable supplement/medication that can be taken without water.

Gelatin has historically been a popular gelling agent for use in preparing gummy compositions. Gelatin is essentially processed collagen, which is a structural protein in animals' connective tissue, skin, and bones. With many people moving to plant-based/vegan diets, gelatin-based gummy compositions are problematic in that they are considered non-vegetarian. Pectin is a plant-based structural polysaccharide which can be used as a gelling agent. The main component of pectin is D-galacturonic acid, and the D-galacturonic acid groups of the polysaccharide chain may be esterified with methyl groups. Pectins are categorized by the degree of esterification of the D-galacturonic acid groups, which refers to the number of esterified galacturonic acid groups expressed as a percentage from 0% to 100% of the total number of galacturonic acid groups present in the molecule. Specifically, pectin is categorized as high-methoxyl (HM) pectin if the degree of esterification is 50% or higher, and low-methoxyl (LM) pectin has a degree of esterification below 50%. While both HM pectin and LM pectin act as gelling agents, their properties are quite different. LM pectin is less commonly used in confectionery products and requires the presence of calcium ions in order to form gels. HM pectin is more often used in confectionery products, and requires the presence of a sweetener and an acid in order to form a gel. The gelling process of HM pectin is pH-sensitive, and careful control of pH is required.

The flavor profiles of these confectionery products are limited by the components used. There are five primary types of taste: sweet, sour, salty, bitter, and savory. This taste is established by various compounds interacting with sensory receptor cells on the taste buds. However, flavor is controlled by more than just taste. For example, odors, temperature, and texture can all be implicated in the resultant flavor being experienced during consumption. Flavor has many variables which are often limited by other limitations associated confectionery products such as buffers typically used.

This background information is provided for the purpose of making known information believed by the applicant to be of possible relevance to the present invention. No admission is necessarily intended, nor should be construed, that any of the preceding information constitutes prior art against the present invention.

It is therefore an object of this disclosure to provide pH stabilizing agents which are able to provide formulators more ability to control the flavor profile of their products.

### SUMMARY

In accordance with the foregoing objectives and others, the present disclosure provides confectionery products having a pH stabilizing agent selected from monopotassium malate, monosodium malate, or combinations thereof. Typically, these products include a food-safe acid such as citric acid or malic acid and a flavorant such as a fruit flavorant (e.g., citrus such as orange, lemon, lime, grapefruit, tangerine, citron, kumquat, yuzu, strawberry, berry). Optionally, the product may contain one or more gelling agents and/or a sweetener. The composition may be, for example, a confectionery or used for producing a product. In some embodiments, the composition is gummy, taffy, licorice, jelly bean, hard candy, tart, or jelly such as a spreadable jelly. In some embodiments, the composition comprises a gellant and/or a sweetener.

For example, compositions (e.g., comestible compositions, sour sensory compositions) are provided having:
a) a pH stabilizing agent comprising monopotassium malate and a food-safe acid (e.g., malic acid, citric acid);
b) one or more flavorants such as fruit (e.g., strawberry, citrus, orange, mixed berry) flavorants;
   wherein the composition has a different flavor profile as compared to an otherwise identical composition having a pH stabilizing agent comprising monosodium malate in place of the monopotassium malate.

In some embodiments, compositions are provided having:
a) a pH stabilizing agent comprising monosodium malate and a food-safe acid (e.g., malic acid, citric acid);
b) one or more flavorants such as fruit (e.g., strawberry, citrus, orange, mixed berry) flavorants;
   wherein the composition has a different flavor profile as compared to an otherwise identical composition having a pH stabilizing agent comprising monopotassium malate in place of the monosodium malate.

Without wishing to be bound by theory, it is believed that the partially neutralized malate salts provide a variation in flavor profile including differences in attributes associated with onset, peak, and linger even in unflavored compositions. These differences, when used with flavorants can augment the resultant flavor profiles of compositions to afford a broader spectrum of flavors within the tight constrictions associated with formulation development.

In some embodiments, the different flavor profile includes a difference in at least one flavor descriptor selected from:
1) complexity (e.g., increased complexity);
2) roundness (e.g., increased roundness);
3) juiciness (e.g., increased juiciness);
4) fruitiness (e.g., increased fruitiness);
5) flavor intensity (e.g., increased flavor intensity);
6) tartness (e.g., decreased tartness, increased tartness);
7) pithiness (e.g., decreased pithiness); and
8) flavor mimic to the taste of natural fruit and/or pulp (e.g., closer flavor mimic to the taste of natural fruit and/or pulp).
   These comparisons may be made to an otherwise identical composition comprising monosodium malate in place of the monopotassium malate or monopotassium malate in place of the monosodium malate. In some embodiments, the comparisons may be made to sodium citrate in place of the monopotassium malate, monosodium malate, or combinations thereof.

The increase or decrease for flavor descriptor each may be observed based on a difference of at least one point (e.g., one point, two points, three points, four points, five points, six points) on a 9-point scale for the flavor descriptor as evaluated by three or more reviewers (e.g., from 3 reviewers, 4 reviewers, 5 reviewers, 6 reviewers, 7 reviewers, 8 reviewers, 9 reviewers, 10 reviewers, 11 reviewers, 12 reviewers, 13 reviewers, 14 reviewers, 15 reviewers, 16 reviewers, 17 reviewers, 18 reviewers, 19 reviewers, 20 reviewers). Reviewers may be asked to ascertain the flavor descriptor assigning a numeric value on a scale from 1-9. The difference in composition is typically statistically significant having a p-value of less than 0.05. An exemplary explanation of the flavor descriptors is found in Tables 1 and 2. Rating these descriptors on a 9 point scale may provide a characterization of the compositions of the present disclosure. For example, the pithiness, or how pithy a composition is, can be associated with a lightly bitter, astringent flavor note associated with the pith (or white membrane in a citrus fruit).

TABLE 1

| Flavor | | | | | | |
|---|---|---|---|---|---|---|
| Descriptor | Complexity | Roundness | Juiciness | Fruity | Tartness | Overcooked |
| Explanation | How | How rounded | How much the | How close | How tart the | How sweet |
| of the | complex is | is the overall | mouth is the | the flavor | flavor comes | is the |
| parameter | the flavor? | experience of | watering after | represents | out | gummy |
| | | the eating | eating has begun | the fruit | | |
| Scale | 1 to 9 | 1 to 9 | 1 to 9 | 1 to 9 | 1 to 9 | 1 to 9 |
| Interpretation | 1 = Flat | 1 = Spiky | 1 = Dry | 1 = Artificial | 1 = Weak | 1 = Mildly |
| | 9 = Complex | 9 = Rounded | 9 = Juicy | 9 = Fruity | 9 = Strong | sweet |
| | | | | | | 9 = Excessively |
| | | | | | | sweet, mutes the |
| | | | | | | flavor |

TABLE 2

| Parameter | Complexity | Juiciness | Pulpy | Real-to-fruit | Tartness | Pithy |
|---|---|---|---|---|---|---|
| Explanation | How | How much | How close the | How close | How tart the | Pertaining |
| of the | complex is | the mouth is | eating | the flavor | flavor comes | to the |
| parameter | the flavor? | the watering | experience is | represents | out | seed/zest/ |
| | | after eating | to the pulp of | the fruit | | seed-like |
| | | has begun | the fruit. | | | |
| Scale | 1 to 9 | 1 to 9 | 1 to 9 | 1 to 9 | 1 to 9 | 1 to 9 |
| Interpretation | 1 = Flat, | 1 = Dry | 1 = Sapless | 1 = Artificial | 1 = Weak | 1 = Fruity |
| | 9 = Complex | 9 = Juicy | 9 = Fleshly | 9 = Real fruit | 9 = Strong | 9 = Bitter |
| | | | | | | rind/seed- |
| | | | | | | like |

For example, when the fruit is citrus flavored (e.g., orange), the different flavor profile in composition having from monopotassum malate may have:
an increased complexity;
an increased juiciness;
a decreased pithiness; and
a closer mimic to the taste and pulp of an orange.
   In some citrus flavored embodiments, the food-safe acid comprises or is citric acid.

In embodiments when the fruit flavor is strawberry, the different flavor profile may have:
an increased roundness;
an increased juiciness;
a decreased tartness; and
a decreased pithiness.
   In some strawberry flavored embodiments, the food-safe acid comprises or is malic acid.

In embodiments when the fruit is mixed berry, the different flavor profile may have:
an increased flavor intensity; and
a decreased tartness.
   In some berry flavored embodiments, the food-safe acid comprises or is malic acid.

For evaluating the taste profile of a given composition, a sample may be tested by e.g., a panel of 1-10 people. In some cases, a trained taster may independently taste the sample(s) first. The taster may be asked to describe the taste profile and score 1-9 or 0-5 to lingering taste profiles including the peak sourness, onset of sourness, and lingering sourness (following removal of a sample from the mouth). The taster may be allowed to re-taste, and then make notes for the sensory attributes perceived. Afterwards, another group of 1-10 tasters may similarly taste the sample(s), record its taste attributes and discuss the samples openly to find a suitable description. Where more than 1 taster disagrees with the results, the tasting may be repeated. For example, on a 0-5 scale, a “5” for peak may be the best score for having a taste that the most sour and conversely a value of 0 near zero may have no sour peak. Similarly, a “5” for bitterness, aftertaste and lingering is not desired. A value of zero or near zero may mean that the bitterness, aftertaste and/or lingering is reduced or is removed. Other taste attributes may include astringency and overall likability and any other favor descriptor described herein (e.g., pithy, real-to-fruit, complexity, juiciness, pulpy, tartness, fruity, overcooked).

The present application is partially premised on the discovery that monopotassium malate is able to differently provide flavor profile augmentation than monosodium malate (and that both are able to provide substantially different flavor profiles that sodium citrate). These profile differences can allow for a wider variety of flavored products such as flavored confectionery products when combined with a food-safe acid. In various embodiments, the pH stabilizing agent comprises a combination of monopotassium malate and monosodium malate (e.g., in a weight ratio of monopotassium malate:monosodium malate of 100:1 to 1:100, from 50:1 to 1:50, from 25:1 to 1:25, from 10:1 to 1:10, from 5:1 to 1:5, from 2:1 to 1:2).

In some embodiments, the weight ratio of the food-safe acid to the monopotassium malate and/or monosodium malate is greater than 1.5:1 (e.g., 1.5:1 to 10:1, 1.5:1 to 5:1, 1.5:1 to 4:1, 2:1 to 3:1).

In various aspects, the composition may comprise:
a) less than (or from 0.1% to) 2% food-safe acid by weight of the composition (e.g., from 0.1% to 1.5%, 0.5%-1.2%, 0.6%, 1%); and/or
b) less than (or from 0.1% to) 1% monopotassium malate and/or monosodium malate by weight of the composition (e.g., 0.1%-0.8%, 0.2%-0.7%, 0.4%-0.7%, 0.5%, 0.2%).

The composition may be in the form of a gummy (e.g., it may comprise a gellant). In various implementations, the gellant comprises pectin (e.g., high-methoxyl pectin, high-methoxyl pectin having a degree of esterification of from 58% to 62%). The composition may comprise from 1-5% gellant by weight of the composition (e.g., 1-2.5%).

In some embodiments, the ratio of the pH stabilizing agent to the flavorant is from 10:1 to 1:10 (e.g., 5:1 to 1:5, 2:1 to 1:2).

The pH stabilizing agent may be incorporated internally in the composition. In some embodiments, the pH stabilizing agent (when present in the composition or used to make the composition) is in powder form and has an average particle size of less than (or from 0.01 microns to) 200 microns (e.g., less than 150 microns, less than 100 microns, from 1 micron to 200 microns, from 1 micron to 150 microns, from 50 microns to 200 microns, from 50 microns to 150 microns). Unless otherwise indicated, particle size identified herein are the volume average particle size and may be measured by dynamic light scattering.

The particle size may be defined by the D90 or D50 value which provide the cumulative distribution of maximum particle size dimension in a sample of particle, where 90% of the distribution lies below the D90 value and 50% of the distribution lies below the D50 value. In some embodiments, the pH stabilizing agent (when present in the composition or used to make the composition) is in powder form and has a D90 of less than (or from 0.01 microns to) 200 microns (e.g., less than 150 microns, less than 100 microns, from 1 micron to 200 microns, from 1 micron to 150 microns, from 50 microns to 200 microns, from 50 microns to 150 microns). In some embodiments, the pH stabilizing agent (when present in the composition or used to make the composition) is in powder form and has a D50 of less than (or from 0.01 microns to) 200 microns (e.g., less than 150 microns, less than 100 microns, from 1 micron to 200 microns, from 1 micron to 150 microns, from 50 microns to 200 microns, from 50 microns to 150 microns).

In some embodiments, the pH stabilizing agent may coat the composition such as be used in a powder acid sanding composition. When in these forms, the pH stabilizing agent comprising the partially neutralized malate (e.g., monosodium malate, monopotassium malate, combinations thereof) may have a similar particle size as the sweetener. For example, the partially neutralized malate and food-safe acid combination may have an average particle size of 200 to 500 microns (e.g., from 250 to 400 microns). In some embodiments, the food-safe acid, monopotassium malate and/or monosodium malate are not used in a powder acid sanding composition.

A citrus (e.g., orange, lemon, lime, grapefruit, tangerine, citron, kumquat, yuzu) flavored (e.g., composition comprising artificial and/or natural citrus flavors) confectionery product is provided comprising a food-safe acid (e.g., citric acid) and monopotassium malate and/or monosodium malate. Additionally, a strawberry flavored (e.g., composition comprising artificial and/or natural strawberry flavors) confectionery is provided comprising a food-safe acid (e.g., malic acid) and monopotassium malate and/or monosodium malate. A berry flavored (e.g., composition comprising artificial and/or natural berry flavors) confectionery is also provided comprising a food-safe acid (e.g., malic acid) and monopotassium malate and/or monosodium malate.

In certain embodiments, the use of a buffering agent comprising monosodium malate, monopotassium malate, or a mixture thereof may provide superior results in the production of HM pectin-based gummy compositions as compared to other buffering agents which are commonly used to produce gummy compositions, such as sodium citrate. The use of a buffering agent comprising monosodium malate, monopotassium malate, or a mixture thereof also advantageously may produce a gummy composition that exhibits a very mild flavor profile, which avoids the dominant acidic note typically found in HM pectin-based gummy compositions (given they are set by acid). In one aspect, there is provided a pH-stabilizing agent for a high-methoxyl pectin-based gummy composition, wherein the pH-stabilizing agent comprises: a buffering agent comprising monosodium malate, monopotassium malate, or a mixture thereof; and a food-safe acid. In another aspect, the use of a buffering agent comprising monosodium malate, monopotassium malate, or a mixture thereof, in combination with a food-safe acid as a pH-stabilizing agent for a high-methoxyl pectin-based gummy composition is provided.

In some embodiments, the composition (e.g., sour sensory composition, comestible composition) of the present disclosure may comprise monopotassium malate and/or monosodium malate and a food-safe acid (e.g., citric acid, malic acid) in a ratio of from 10:1 to 1:10 (e.g., from 5:1 to 1:5, 1.5:1 to 10:1, 1.5:1 to 5:1, 1.5:1 to 4:1, 2:1 to 3:1). In various implementations, the composition is in powder or granular form. The composition may comprise an intimate admixture of said food-safe acid and said monopotassium malate and/or monosodium malate. In some embodiments, the composition has a median particle size of less than 200 microns. In some embodiments, the wherein food-safe acid has a particle size of less than 200 microns. In certain aspects, the monopotassium malate and/or monosodium malate has a particle size of less than 200 microns. In some embodiments, the composition further comprises a sweetener (e.g., sucrose).

A composition (e.g., sour sensory composition, comestible composition) of the present disclosure may comprise a fruit flavor, a food-safe acid (e.g., citric acid, malic acid) and a partially hydrogenated malic acid salt selected from monopotassium malate and/or monosodium malate. In some embodiments, the comestible composition is a gummy, a beverage, a hard candy, a chewable candy or a taffy or taffy type confectionery. The monopotassium malate and/or monosodium malate and food-safe acid are dispersed homogenously throughout at least a portion of said comestible composition. In various implementations, the food-safe acid, monopotassium malate and/or monosodium malate are coated onto an exterior surface of said comestible composition. In specific aspects, the fruit flavor is a citrus flavor. For example, the citrus flavor may be selected from orange, tangerine, lemon, lime, and grapefruit.

For example, the composition (e.g., sour sensory composition, comestible composition) may comprise an orange flavor and monopotassium malate and/or monosodium malate. In some embodiments, the comestible composition may further comprise a food-safe acid (e.g., citric acid, malic acid). In some embodiments, the weight ratio of the food-safe acid (e.g., citric acid, malic acid) to monopotassium malate and/or monosodium malate is from 10:1 to 1:10 (e.g., 5:1 to 1:5, 10:1 to 1:1, 5:1, to 1.5:1, 4:1 to 1.5:1, 2:1 to 3:1). In some embodiments, the comestible composition comprises less than 1.5% food-safe acid (e.g., citric acid, malic acid) by weight of the comestible composition. In certain aspects, the comestible composition may comprise from 0.5% to 1.1% (e.g., 0.6%, 1%) food-safe acid by weight of the comestible composition. In some embodiments, the comestible composition may comprise less than (or from 0.1% to) 0.6% monopotassium malate and/or monosodium malate by weight of the composition. In some embodiments, the comestible composition may comprise less than (or from 0.1% to) 0.3% monopotassium malate and/or monosodium malate by weight of the composition.

Methods of preparing a composition are also provided which may comprise:
a) combining (e.g., by mixing) water, monopotassium malate, and a food-safe acid (e.g., malic acid, citric acid), a flavorant (e.g., a fruit flavorant such as citrus flavor, strawberry flavor, berry flavor), a sweetener, and optionally a gelling agent to form a candy mass.
   The combining step may comprise:
A1) combining the water, and monopotassium malate, flavorant, sweetener, and optional gelling agent to form a pre-molded candy mass; and
A2) adding the food-safe acid to the pre-molded candy mass to form the candy mass.
   The pre-molded candy mass may have a Brix value of from 68 to 85 (e.g., from 75 to 85).

In yet another aspect, there is provided a method of preparing a gummy composition comprising: (a) combining: a gelling agent comprising high-methoxyl pectin, a sweetening agent, water, and a buffering agent comprising monosodium malate, monopotassium malate, or a mixture thereof; under mixing and heating conditions to form a pre-molding candy mass; (b) adding a food-safe acid to the pre-molding candy mass under mixing conditions to form an acidified candy mass; and (c) allowing the acidified candy mass to set to form the gummy composition; wherein the acidified candy mass has a pH of from 3.2 to 3.6.

### BRIEF DESCRIPTION OF FIGURES

FIG. TA is a chart illustrating that monosodium malate holds the pH of an acidified candy mass within the HM pectin setting range (pH 3.2-3.6) better than sodium citrate over a range of buffer amounts when combined with malic acid or citric acid, according to Example 1. All percentages are wt % (i.e. weight percent) based on the acidified candy mass.

FIG. 1B illustrates gummy compositions prepared according to Example 1, using monosodium malate or sodium citrate as the buffering agent, and malic acid as the food-safe acid.

FIG. 1C illustrates gummy compositions prepared according to Example 1, using monosodium malate or sodium citrate as the buffering agent, and citric acid as the food-safe acid.

FIG. 2 is a chart illustrating that monosodium malate holds gummy composition pH within the optimal HM pectin setting range (pH 3.2-3.6) better than sodium citrate when active agents are present. All percentages are wt % based on the acidified candy mass.

FIG. 3 is a chart illustrating sour lexicon ratings for HM pectin-based gummies with various acid and buffering agent combinations.

FIG. 4 is a chart illustrating pH versus wt % acid at 0.1 wt % buffering agent (monosodium malate). All percentages are wt % based on the acidified candy mass.

FIG. 5 compares the peak, onset, and lingering sweetness measurements of unflavored pectin gummies.

FIG. 6A provides the measured flavor descriptors comparing orange flavored gummies made with different buffers. FIG. 6B provides the measured flavor descriptors comparing strawberry flavored gummies made with different buffers. FIG. 6C provides the measured flavor descriptors comparing mixed berry flavored gummies made with different buffers.

### DETAILED DESCRIPTION

Detailed embodiments of the present disclosure are disclosed herein; however, it is to be understood that the disclosed embodiments are merely illustrative of the disclosure that may be embodied in various forms. In addition, each of the examples given in connection with the various embodiments of the disclosure is intended to be illustrative, and not restrictive.

All terms used herein are intended to have their ordinary meaning in the art unless otherwise provided. All concentrations are in terms of percentage by weight of the specified component relative to the entire weight of the topical composition, unless otherwise defined.

As used herein, “a” or “an” shall mean one or more. As used herein when used in conjunction with the word “comprising,” the words “a” or “an” mean one or more than one. As used herein “another” means at least a second or more.

As used herein, all ranges of numeric values include the endpoints and all possible values disclosed between the disclosed values. The exact values of all half integral numeric values are also contemplated as specifically disclosed and as limits for all subsets of the disclosed range. For example, a range of from 0.1% to 3% specifically discloses a percentage of 0.1%, 1%, 1.5%, 2.0%, 2.5%, and 3%. Additionally, a range of 0.1 to 3% includes subsets of the original range including from 0.5% to 2.5%, from 1% to 3%, from 0.1% to 2.5%, etc. It will be understood that the sum of all weight % of individual components will not exceed 100%.

The open ended comprise may include consist predominantly, consist essentially, or consist of By “consist predominantly” it is meant that the indicated components are the predominant elements (e.g., as present in over 50% by weight). If an element consists predominantly of a single component, that single component may be present with the highest weight percentage. By “consist essentially” it is meant that the ingredients include only the listed components along with the normal impurities present in commercial materials and with any other additives present at levels which do not affect the operation of the embodiments disclosed herein, for instance at levels less than 5% by weight or less than 1% or even 0.5% by weight.

The terms “gummy composition/gummies” have historically been used to refer to gelatin-containing or gelatin-based confectionery products, whereas the terms “jelly/jellies” have historically been used to refer to pectin/agar-based confectionery products. This has changed in recent years, particularly with the advent of the “vegan gummy” which does not contain any gelatin. Those of skill in the art will appreciate that the terms “gummy/gummies” and “jelly/jellies” are now used interchangeably in the confectionery industry.

As used herein, the term “high-methoxyl (HM) pectin-based gummy composition” as used herein refers to gummy compositions where HM pectin is the only gelling agent present.

Taste generally describes the sensory response related to taste receptors. The quality of taste may be expressed as the interplay of descriptors. For example, “juicy” may be associated with mouthfeel of a 100% juice beverage; “sour” may be associated with acids in solution; “pulpy” may be associated with pulp in a fresh squeezed orange juice; and “peely” may be associated with the peel and skin of citrus fruits. This list of descriptors is not limitative and descriptors may change depending on the nature of the flavor composition.

Compositions

The products of the present disclosure have enhanced flavor profiles as a result of the unique combinations buffers (e.g., monosodium malate, monopotassium malate, combinations thereof) and food-safe acids (e.g., citric acid, malic acid) provided herein. Typically, these enhancements are more pronounced when combined with sweeteners such as sugar and/or flavorants such as fruit flavorants (e.g., artificial and/or natural ingredients). In particular, the present application also relates to the preparation of pectin-based gummy composition such as high-methoxyl (HM) pectin-based gummy composition. As noted above, pectin is categorized as high-methoxyl (HM) pectin if the degree of esterification is 50% or higher, and low-methoxyl (LM) pectin has a degree of esterification below 50%.

Non-limiting examples of food-safe acids for use in the compositions of the present disclosure include citric acid, malic acid, tartaric acid, fumaric, acetic acid, oxalic acid, tannic acid, benzoic acid, butyric acid, lactic acid, phosphoric acid, and combinations thereof. In some embodiments, food-safe acid is selected from citric acid, malic acid, or mixtures thereof.

The use of a buffering agent comprising monosodium malate, monopotassium malate, or a mixture thereof also advantageously produces compositions such as HM pectin-based gummy compositions that may exhibit a mild flavor profile and/or avoids the dominant acidic note typically found in HM pectin-based gummy compositions set by acid. HM pectin-based gummy compositions prepared using malate salts as described herein are expected to be particularly useful for masking ingredients having an off-note that is intensified by acid, and/or for preparing HM pectin-based gummies having a variety of flavors outside the typical fruit flavors (e.g. birthday cake).

Suitable flavoring agents may be natural or artificial flavors. In a particular embodiment, the flavoring agent comprises an essential oil, such as an oil derived from a plant or a fruit, peppermint oil, spearmint oil, other mint oils, clove oil, cinnamon oil, oil of wintergreen, bay, thyme, cedar leaf, nutmeg, allspice, sage, mace, and almonds. In another particular embodiment, the flavoring agent comprises a plant extract or a fruit essence such as apple, banana, watermelon, pear, peach, grape, strawberry, raspberry, cherry, plum, pineapple, apricot, and mixtures thereof. In still another particular embodiment, the flavoring agent comprises a citrus flavor, such as an extract, essence, or oil of lemon, lime, orange, tangerine, grapefruit, citron, or kumquat. In various implementations, the flavorant includes one or more flavors selected from a mixed berry flavor, a mulberry flavor, a cherry flavor, a strawberry flavor, a citrus flavor, a lemon flavor, a lime flavor, an orange flavor, a grape flavor, a vanilla flavor, a chocolate flavor, a caramel flavor, a mint flavor, a spearmint flavor, a wintergreen flavor, and a menthol flavor.

The compositions of the present disclosure may include a characterizing flavor. The term “characterizing flavor” refers to a flavor that is perceived by an individual to be predominant upon consumption by the individual (and is related to the several flavor descriptors which may be used to characterize the compositions such as Real-To-Fruit). In one embodiment, the characterizing flavor may be a citrus flavor derived from the genus citrus, for example, lemon, lime, orange, tangerine, grapefruit, pomelo, key lime, kaffir lime, clementine, mandarin, blood orange, kumquat or yuzu. Accordingly, an individual may perceive a predominant citrus flavor upon consumption of the composition. Suitable citrus characterizing flavors include, for example, lime or lemon flavoring available from Givaudan Flavors Corporation.

The flavor composition may include the characterizing flavor in an amount from 0.01 to 10%, in another embodiment from 0.01 to 5%, in yet another embodiment from 0.01 to 1%, or any individual number within the range, by weight of the flavor composition. In another embodiment, a consumable may include the characterizing flavor in an amount from 0.001 to 0.5%, in another embodiment from 0.01 to 0.3%, in yet another embodiment from 0.02 to 0.1%, or any individual number within the range, by weight of the consumable.

Non-limiting examples of suitable flavor-providing ingredients include natural flavors, artificial flavors, spices, seasonings, and the like. These include synthetic flavor oils and flavoring aromatics and/or oils, oleoresins, essences, extracts, concentrates, and distillates, and combinations thereof. Flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil, useful flavoring agents include artificial, natural and synthetic fruit flavors such as vanilla, and citrus oils including lemon, orange, lime, grapefruit, yuzu, sudachi, and fruit essences including apple, pear, peach, grape, raspberry, blackberry, gooseberry, blueberry, strawberry, cherry, plum, prune, raisin, cola, guarana, neroli, pineapple, apricot, banana, melon, apricot, cherry, tropical fruit, mango, mangosteen, pomegranate, papaya, and so forth. In some embodiments, the other flavorant ingredients include aldehydes and esters such as cinnamyl acetate, cinnamaldehyde, citral diethylacetal, dihydrocarvyl acetate, eugenyl 49 formate, p-methylamisol, and so forth can be used. Further examples of aldehyde flavorings include acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), and the like. Some compositions of the present disclosure may include glucose syrup, and/or carriers such as gelatin, sugar, fructose, and corn syrup. Pectin from apple or citrus may be used. Several flavorings include citrus flavor, berry mix flavor, tropical fruit flavor, ginger flavor, tangerine flavor, and tart cherry. Typical colors include carrot juice color, beet juice color, genipap fruit color, spinach color, and artificial FD&C colors.

The gelling process of HM pectin is pH-sensitive, and careful control of pH is required, in particular where HM pectin is the main or only gelling agent in the composition. Below a pH of 3.2, a pre-gel forms, and the composition sets up too quickly for deposit or sets up unevenly (bumpy texture). Above pH 3.6, the gummy composition does not set up, or is too soft. In view of its pH sensitivity, HM pectin has earned a reputation as being difficult to work with especially where it is the primary or only gelling agent in a composition. The pH stabilizing agents of the present disclosure are able to provide compositions within the narrow pH range while also providing an unexpected enhancement to the flavor of compositions.

Many things can affect the pH of a solution used to prepare composition (e.g., gummy composition), including the source of the water used in the processes, as well as lot-to-lot variability in the HM pectin used in the processes. The present inventor(s) have found that the use of a buffering agent comprising monosodium malate, monopotassium malate, or a mixture thereof, provides superior results in the production of HM pectin-based gummy compositions as compared to other buffering agents which are commonly used to produce gummy compositions, such as sodium citrate. The use of a buffering agent comprising monosodium malate, monopotassium malate, or a mixture thereof advantageously produces an acidified candy mass for HM pectin-based gummy compositions which consistently maintains a desired pH of from 3.2 to 3.6, which is optimal for gelling of HM pectin, across a range of buffering agent and/or food-safe acid concentrations, which results in consistent production of high-quality (i.e. stable) gummy composition products. The fact that the acidified candy mass consistently maintains a desired pH of from 3.2 to 3.6 across a range of buffering agent and/or food-safe acid concentrations means that production of the HM pectin-containing gummy compositions is less sensitive to pH-affecting factors, provides a consistent product, and is amenable to scale-up on an industrial scale.

In one embodiment, there is provided a pH-stabilizing agent for a high-methoxyl pectin-based gummy composition, wherein the pH-stabilizing agent comprises: a buffering agent comprising monosodium malate, monopotassium malate, or a mixture thereof; and a food-safe acid.

In another embodiment, the use of a buffering agent comprising monosodium malate, monopotassium malate, or a mixture thereof, in combination with a food-safe acid as a pH-stabilizing agent for a high-methoxyl pectin-based gummy composition is provided.

In one embodiment, the buffering agent comprises monosodium malate. In another embodiment, the buffering agent consists essentially of, or consists of, monosodium malate.

In another embodiment, the food safe acid is selected from citric acid, malic acid, lactic acid, tartaric acid, fumaric acid or mixtures thereof. In yet another embodiment, the food safe acid is selected from citric acid, malic acid, or mixtures thereof. In various embodiments, the pH stabilizing agent comprises a combination of monopotassium malate and monosodium malate (e.g., in a weight ratio of monopotassium malate:monosodium malate of 100:1 to 1:100, from 50:1 to 1:50, from 25:1 to 1:25, from 10:1 to 1:10, from 5:1 to 1:5, from 2:1 to 1:2).

In another embodiment, the high-methoxyl pectin-based gummy composition comprises high-methoxyl pectin having a degree of esterification of from 58% to 62%.

In another embodiment, the high-methoxyl pectin-based gummy composition does not comprise gelatin or other gelling agents other than the high-methoxyl pectin.

In one embodiment, the composition such as high-methoxyl pectin-based gummy composition comprises a sweetener, such as sucrose. In other embodiments, the sweetener can include sucrose, maltitol, inulin, soluble fiber (corn, tapioca, pea), or mixtures thereof. Sweetening agents may also be used in the compositions of the present disclosure. In some embodiments, the amount of sugar and/or sweetener is 5 to 99 wt % of the composition. In one embodiment, the sweetening agent constitutes 1% to 15%, or 2% to 10% dry weight of the composition (e.g., gummy).

In another embodiment, the compositions such as high-methoxyl pectin-based gummy composition comprises a sweetener such as a syrup selected from corn syrup, tapioca syrup, or a combination thereof. In another embodiment, the syrup is corn syrup.

In another embodiment, the compositions such as high-methoxyl pectin-based gummy composition further comprises an active agent. In another embodiment, the active agent is selected from a nutraceutical agent or a pharmaceutical agent. Exemplary active agents can include botanicals, vitamins, minerals, spices, natural oils, plant fiber, OTC drugs, and pharmaceutical drugs. In still another embodiment, the active agent comprises a vitamin such as ascorbic acid (Vitamin C), or a vitamin blend such as a B vitamin blend. In another embodiment, the active agent comprises essential mineral salts (e.g. magnesium, calcium). In one embodiment, the active agent may be present in an amount of, for example, less than 10% by weight of the composition (e.g., less than 5%, less than 1%, less than 0.5%, from 0.01-10%, 0.15 wt %).

In still another embodiment, the composition such as high-methoxyl pectin-based gummy composition further comprises a flavoring agent and/or a coloring agent. Exemplary flavoring agents can include essential oils, natural flavors, natural and artificial flavors, artificial flavors, botanicals, and spices. Exemplary coloring agents can include FD&C colors, or colors derived from fruits and vegetables. In some embodiments, the ratio of the pH stabilizing agent to the flavorant is from 10:1 to 1:10 (e.g., 5:1 to 1:5, 2:1 to 1:2).

In another embodiment, the composition such as high-methoxyl pectin-based gummy composition comprises the buffering agent in an amount of from 0.05 wt % to 0.4 wt %, and the food safe acid in an amount of from 0.3 wt % to 0.7 wt %.

In another embodiment, the composition such as high-methoxyl pectin-based gummy composition comprises the buffering agent in an amount of from 0.05 wt % to 0.4 wt %, the food safe acid in an amount of from 0.3 wt % to 0.7 wt %, high-methoxyl pectin in an amount of from 1.0 to 2.5 wt %, sucrose or other sweetener in an amount of from 20 wt % to 40 wt %, syrup in an amount of from 30 wt % to 50 wt %, and water in an amount of from 20 wt % to 30 wt %.

The compositions of the present disclosure may contain at least one of a colorant, opacifier, flavorant, sweetener, preservative, or gellant. Suitable colorants include, but are not limited to, azo dye, quinophthalone dye, triphenylmethane dye, xanthene dye, iron oxide, iron hydroxide, titanium dioxide, sunset yellow, allura red, amaranth, koki neil red, azogeranin, tartrazine, brilliant black, canthaxanthin, patent blue, fast green, brilliant blue, acid green, erythrosine, quinoline yellow, indigotin, curcumin, carbon black and/or combinations thereof. Suitable flavorants include, but are not limited to, a natural flavor oil, an artificial flavor oil, a synthetic flavor oil, a flavoring aromatic, a flavoring oils, an oleoresin, plant extract, leaf extract, flower extract, fruit extract, citrus oil, spearmint oil, peppermint oil, Eucalyptus oil, nutmeg oil, allspice oil, mace, almond oil, menthol oil, citrus oil, lemon oil, orange oil, lime oil, grapefruit oil and/or combinations thereof. In embodiments, compositions may include citrus flavor, ginger flavor, berry flavor, cherry flavor, vanilla flavor or combinations thereof. Suitable sweeteners include, but are not limited to, agave syrup, Stevia, erythritol, xylitol, sorbitol, yacon syrup, aspartame, saccharin, cyclamate, sucralose, monk fruit extract and/or combinations thereof. In some embodiments, the sweetener can include a sugar alcohol such as erythritol, xylitol, sorbitol, glycerin. In some embodiments, the sweetner can include a disaccharide such as sucrose, lactose, or maltose. In various implementations, the composition may include sodium chloride. The compositions may include monosaccharides, such as glucose, fructose, allulose or galactose; disaccharides such as sucrose, lactose or maltose; and/or sugar alcohols as sorbitol, mannitol, maltitol, xylitol, erythritol, or isomalt.

The sucrose may be in various solid forms including but not limited to standard (e.g. granulated) table sugar, powdered sugar, caster sugar, icing sugar, sugar syrup, unrefined sugar, raw sugar cane. In some embodiments, the sweetener composition comprises silk sugar, such as the silk sugar manufactured by British Sugar Plc. Silk sugar is an ultrafine sugar preferably having a D90 particle size of less than 30 μm, or less than 25 μm, or 20 μm or less. Silk sugar may have a D50 particle size of less than 15 μm, or less than 10 μm, or less than 9 μm, or 8 μm or less. More preferably, silk sugar has a D90 particle size of 20 μm and a D50 particle size of 8 μm.

Suitable gelling agents include but are not limited to gelatin, gum arabic, pullulan, pectin, agar, carrageenan, clear gum, xanthan gum, alginic acid, alginates such as sodium alginate, potassium alginate, ammonium alginate, calcium alginate, locust bean gum, tapioca starch, konjac, ficus pumila, gellan gum, dextrin, maltodextrin, modified food starches, corn starch. In one embodiment, the concentration of the gelling agent constitutes between 0.5% to 30% dry weight, or 1% to 15% dry weight of the gummi confectionery. The gelling agent is typically present in an aqueous solution. Accordingly, the gummy confectionery typically contains water as the balance of the composition. In one embodiment, the water may constitute 40% to 90%, or 50% to 80% by weight of the composition (e.g., gummy confectionery).

Method of Preparing Compositions

Methods of preparing a composition are also provided which may comprise:
a) combining (e.g., by mixing) water, monopotassium malate, and a food-safe acid (e.g., malic acid, citric acid), a flavorant (e.g., a fruit flavorant such as citrus flavor, strawberry flavor, berry flavor), a sweetener, and optionally a gelling agent to form a candy mass.
   The combining step may comprise:
A1) combining the water, and monopotassium malate, flavorant, sweetener, and optional gelling agent to form a pre-molded candy mass; and
A2) adding the food-safe acid to the pre-molded candy mass to form the candy mass.

The pre-molded candy mass may have a Brix value of from 68 to 85 (e.g., from 75 to 85).

In one embodiment, there is provided a method of preparing a gummy composition comprising: (a) combining: a gelling agent comprising high-methoxyl pectin, a sweetening agent, water, and a buffering agent comprising monosodium malate, monopotassium malate, or a mixture thereof; under mixing and heating conditions to form a pre-molding candy mass; (b) adding a food safe acid to the pre-molding candy mass under mixing conditions to form an acidified candy mass; and (c) allowing the acidified candy mass to set to form the gummy composition; wherein the acidified candy mass has a pH of from 3.2 to 3.6.

In one embodiment, the sweetening agent comprises sucrose. In other embodiments, the sweetening agent comprises sucrose, maltitol, inulin, soluble fiber (corn, tapioca, pea, etc.), or mixtures thereof.

In another embodiment, the pre-molding candy mass further comprises a second sweetening agent.

In one embodiment, the second sweetening agent comprises a syrup, such as corn syrup, tapioca syrup, or a combination thereof. In another embodiment, the second sweetening agent comprises corn syrup.

In another embodiment, the pre-molding candy mass has a Brix value of from 68 to 85, or of from 75 to 85.

In another embodiment, HM pectin is the only gelling agent in the gummy composition (i.e. the gummy composition does not comprise gelatin or other gelling agents besides HM pectin). In another embodiment, the high-methoxyl pectin has a degree of esterification of from 58% to 62%.

In another embodiment, the buffering agent consists of monosodium malate—i.e. monosodium malate is the only pH stabilizing food safe salt present in the composition.

In another embodiment, the method further comprises adding an active agent to the pre-molding candy mass of step (a) prior to forming the acidified candy mass in step (b). In another embodiment, the active agent is selected from a nutraceutical agent or a pharmaceutical agent. Exemplary active agents can include botanicals, vitamins, minerals, spices, natural oils, plant fiber, OTC drugs, and pharmaceutical drugs. In yet another embodiment, the active agent comprises a vitamin such as ascorbic acid (Vitamin C), or a vitamin blend such as a B vitamin blend. In yet another embodiment, the active agent comprises an antibiotic. In another embodiment, the active agent comprises essential mineral salts (e.g. magnesium, calcium). The wt % of the active agent may be readily determined by the skilled worker. In one embodiment, the active agent may be present in an amount of 0.15 wt % of the acidified candy mass.

In another embodiment, the method further comprises adding a flavoring agent and/or a coloring agent to the pre-molding candy mass of step (a) prior to forming the acidified candy mass in step (b). Exemplary flavoring agents can include essential oils, natural flavors, natural and artificial flavors, artificial flavors, botanicals, and spices. Exemplary coloring agents can include FD&C colors, or colors derived from fruits and vegetables.

In another embodiment, the acidified candy mass comprises the buffering agent in an amount of from 0.05 wt % to 0.4 wt %, and the food safe acid in an amount of from 0.3 wt % to 0.7 wt %. In yet another embodiment, the acidified candy mass comprises the buffering agent in an amount of from 0.05 wt % to 0.4 wt %, and the food safe acid in an amount of from 0.3 wt % to 0.7 wt %, high-methoxyl pectin in an amount of from 1.0 to 2.5 wt %, sucrose in an amount of from 20 wt % to 40 wt %, syrup in an amount of from 30 wt % to 50 wt %, and water in an amount of from 20 wt % to 30 wt %.

As the skilled worker will appreciate, HM pectin can exhibit clumping when mixed with water. Thus, the HM pectin can be combined with water under high shear mixing conditions in step (a) of the method, or the HM pectin can be blended with a portion of the sweetener (e.g. sucrose) prior to mixing with water, which can reduce clumping of the HM pectin. The HM pectin is dispersed into water and boiled to hydrate the pectin and create a HM pectin solution (without or without sweetener present). Then, one or more dry or syrup sweeteners can be added to the pectin solution, or, alternatively, the one or more sweeteners can be cooked separately as a sweetener system to a specific Brix and then can be mixed with the pectin solution. Once combined, the pre-molding candy mass is cooked until a desired target Brix level is reached (e.g. 68-85, or 75-85).

Those of skill in the art will further appreciate that the buffering agent comprising monosodium malate, monopotassium malate, or a mixture thereof can be dispersed into the HM pectin solution, the sweetener system, etc. and can also be added in step (a) after cooking a mixture of the HM pectin, sweetening agent, and water. The buffering agent comprising monosodium malate, monopotassium malate, or a mixture thereof is preferably incorporated into the pre-molding candy mass before the addition of any active agent, coloring agent, or flavoring agent thereto.

An exemplary and non-limiting method of preparing a gummy composition comprises: (i) combining: a gelling agent comprising high-methoxyl pectin, a sweetening agent (e.g. sucrose), and water, under mixing and heating conditions to form a first solution; (ii) adding a second sweetening agent (e.g. syrup, or combination of sucrose and syrup) to the first solution under mixing and heating conditions to form a second solution; (iii) continuing to heat the second solution under mixing conditions to form a concentrated mixture having a desired Brix value (e.g. 68-85, or 75-85); (iv) adding a buffering agent comprising monosodium malate, monopotassium malate, or a mixture thereof to the concentrated mixture under mixing conditions to form a pre-molding candy mass; (v) adding a food safe acid to the pre-molding candy mass under mixing conditions to form an acidified candy mass; and (vi) allowing the acidified candy mass to set to form the gummy composition; wherein the acidified candy mass has a pH of from 3.2 to 3.6.

In one embodiment, step (i) further comprises heating the water prior to combining the water with the HM pectin gelling agent and the sweetening agent. In another embodiment, step (i) further comprises heating the water to a boiling point prior to combining the water with the HM pectin gelling agent and the sweetening agent. In one embodiment, step (i) comprises heating the combined HM pectin, sweetening agent, and water to a boiling point and boiling for 1.5 to 2.5 minutes, or for 2 minutes.

In one embodiment, step (ii) comprises heating the combined HM pectin, sweetening agents, and water to a boiling point to form the second solution.

In one embodiment, continuing to heat the second solution (step (iii)) comprises boiling the second solution until the concentrated mixture having the desired Brix value is formed.

In another embodiment, step (iv) further comprises heating the concentrated mixture to maintain a temperature of from 80° C. to 95° C., or from 82° C. to 93° C. (180-200° F.), while adding the buffering agent to form the pre-molding candy mass.

another embodiment, step (v) further comprises heating the pre-molding candy mass to maintain a temperature of from 80° C. to 95° C., or from 82° C. to 93° C. (180-200° F.), while adding the food safe acid to form the acidified candy mass.

### EXAMPLES

The following examples illustrate specific aspects of the instant description. The examples should not be construed as limiting, as the example merely provides specific understanding and practice of the embodiments and its various aspects.

Materials and Methods

Materials

For Examples 1, 2, 3, and 4, the following ingredients were used: buffered HM pectin, Extra Fine Granulated Cane Sugar, 43 DE Tapioca Syrup, Granulated Anhydrous Citric Acid, Fine Granular Trisodium Citrate Dihydrate (sodium citrate), Granulated Malic Acid (Regular, Food-safe—FCC) from Bartek Ingredients, Inc., and Monosodium malate (i.e. monosodium malate) from Bartek Ingredients, Inc.

For Example 2, the following active agents were used: Pure Ascorbic Acid Powder, and a Vitamin B Blend (with Niacin, Vitamin B6, and Vitamin B12).

It should be noted that reference to “Buffer” in the Examples/Figures refers to the buffering agent (monosodium malate or sodium citrate), and reference to “Acid” in the Examples/Figures refers to the food-safe acid (malic acid or citric acid).

Methods

Procedure Used for Example 1:

638 g of distilled water was heated to a boiling point. 220 g of sucrose was mixed with 44 g of buffered HM pectin until well blended. The blend of pectin and sucrose was slowly sprinkled into the boiling water while quickly whisking to ensure proper dispersal. Once all of pectin/sucrose blend was whisked in, the solution was brought back to a boil and boiled for approximately 2 minutes to ensure full hydration. Then 924 g of tapioca syrup and 374 g of sucrose were added to the solution (slowly to prevent dropping the temperature below 180° F. (82° C.). The solution was brought to a boil and continued to boil until it reached 81° Brix. The heat was reduced to hold between 180-200° F. (82° C. to 93° C.). A 25% monosodium malate solution or 30% sodium citrate solution was then added in amounts as specified in the Examples below (i.e. to achieve a final wt % as specified in the Examples below), and mixed thoroughly (60 seconds) to ensure proper dispersal to form the pre-molding candy mass. A 50% malic acid solution or a 50% citric acid solution was then added in amounts specified in examples below (i.e. to achieve a final wt % as specified in the Examples below), and mixed thoroughly and as quickly as possible (60 seconds) to ensure proper dispersal. The mixture (acidified candy mass) was then deposited between 180° F.-200° F. (82° C. to 93° C.) into silicon molds at approximately 20-30 g per piece.

Procedure Used for Example 2:

638 g of distilled water was heated to a boiling point. 220 g of sucrose was mixed with 44 g of buffered HM pectin until well blended. The blend of pectin and sucrose was slowly sprinkled into the boiling water while quickly whisking to ensure proper dispersal. Once all of pectin/sucrose blend was whisked in, the solution was brought back to a boil and boiled for approximately 2 minutes to ensure full hydration. Then 924 g of tapioca syrup and 374 g of sucrose were added to the solution (slowly to prevent dropping the temperature below 180° F. (82° C.)). The solution was brought to a boil and continued to boil until reached 78° Brix. The heat was reduced to hold between 180-200° F. (82° C. to 93° C.). A 25% monosodium malate solution or 30% sodium citrate solution was then added in amounts as specified in Examples below (i.e. to achieve a final wt % as specified in the Examples below), and mixed thoroughly (60 seconds) to ensure proper dispersal. A 30% ascorbic acid solution or Vitamin B Blend Powder was then added in amounts specified in examples below (i.e. to achieve a final wt % as specified in the Examples below), and mixed thoroughly and as quickly as possible (60 seconds) to ensure proper dispersal in the pre-molding candy mass. A 50% malic acid solution or a 50% citric acid solution was then added to the pre-molding candy mass in amounts specified in examples below (i.e. to achieve a final wt % as specified in the Examples below), and mixed thoroughly and as quickly as possible (60 seconds) to ensure proper dispersal. The mixture (acidified candy mass) was then deposited between 180° F.-200° F. (82° C. to 93° C.) into silicon molds at approximately 20-30 g per piece.

Procedure Used for Example 3 and 4:

638 g of distilled water was heated to a boiling point. 220 g of sucrose was mixed with 44 g of buffered HM pectin until well blended. The blend of pectin and sucrose was slowly sprinkled into the boiling water while quickly whisking to ensure proper dispersal. Once all of pectin/sucrose blend was whisked in, the solution was brought back to a boil and boiled for approximately 2 minutes to ensure full hydration. Then 924 g of tapioca syrup and 374 g of sucrose were added to the solution (slowly to prevent dropping the temperature below 180° F. (82° C.)). The solution was brought to a boil and continued to boil until reached 78° Brix. The heat was reduced to hold between 180-200° F. (82° C. to 93° C.). A 25% monosodium malate solution or 30% sodium citrate solution was then added in amounts as specified in Examples below (i.e. to achieve a final wt % as specified in the Examples below), and mixed thoroughly (60 seconds) to ensure proper dispersal to form the pre-molding candy mass. A 50% malic acid solution or a 50% citric acid solution was then added in amounts specified in examples below (i.e. to achieve a final wt % as specified in the Examples below), and mixed thoroughly and as quickly as possible (60 seconds) to ensure proper dispersal. The mixture (acidified candy mass) was then deposited between 180° F.-200° F. (82° C. to 93° C.) into silicon molds at approximately 20-30 g per piece.

### Example 1—Monosodium Malate Holds Gummy Composition pH within HM Pectin Setting Range (pH 3.2-3.6) Better than Sodium Citrate Over a Range of Buffer Amounts

Four acid/buffer combinations were tested in the pectin gummy formula (per above process as described in Materials and Methods): malic acid/monosodium malate, malic acid/sodium citrate, citric acid/monosodium malate, citric acid/sodium citrate, having 0.375% acid, 5 levels of buffer (0.05%, 0.1%, 0.2%, 0.3%, 0.4%), where all percentages are wt % based on the acidified candy mass.

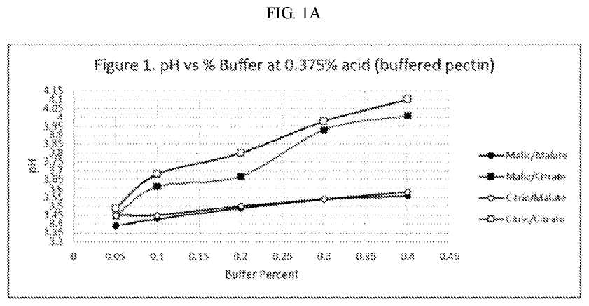

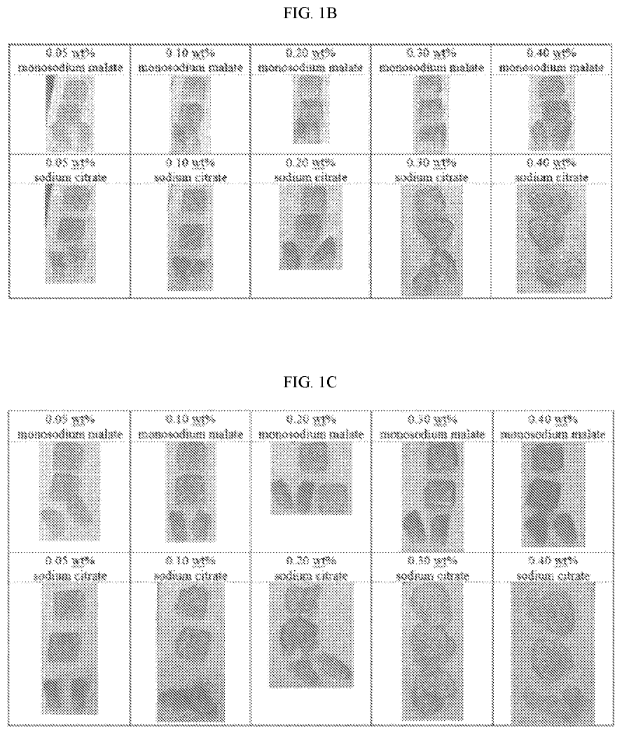

FIG. 1A is a chart illustrating the pH of the acidified candy mass under the conditions tested. All monosodium malate-containing formulas held pH within the desired range, and produced high-quality (stable) gummy compositions. However, 8/10 sodium citrate-containing formulas rose above pH 3.6, and did not produce consistent gummy composition products across the ranges tested.

FIG. 1B illustrates gummy compositions prepared according to Example 1, using monosodium malate or sodium citrate as the buffering agent, and malic acid as the food-safe acid. All monosodium malate formulas (top row) set-up into stable pieces, easily popped out of molds. However, ⅗ sodium citrate formulas (bottom row) popped out of molds—0.05 wt % and 0.10 wt % were stable pieces, 0.20 wt % was soft/sticky and did not hold its shape as well when cut in half.

FIG. 1C illustrates gummy compositions prepared according to Example 1, using monosodium malate or sodium citrate as the buffering agent, and citric acid as the food-safe acid. All monosodium malate formulas (top row) set-up into stable pieces, easily popped out of molds. ⅕ sodium citrate formulas (bottom row) set-up into a stable piece and easily popped out of mold (0.05 wt % buffer). Remaining sodium citrate formulas did not set-up well and had pre-gel.

### Example 2—Monosodium Malate Holds Gummy Composition pH within HM Pectin Setting Range (pH 3.2-3.6) Better than Sodium Citrate when Active Agents are Present

Active ingredients are known to affect pH in gummy formulas, making it harder to remain in the 3.2-3.6 range.

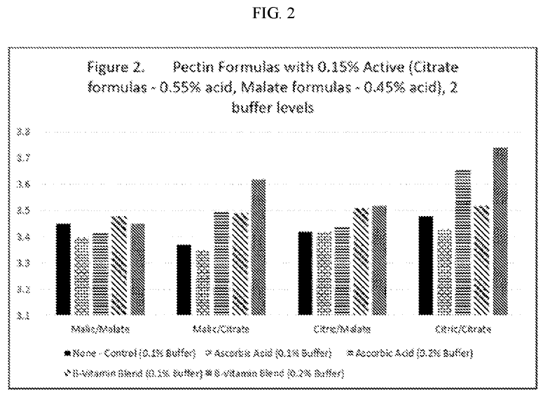

Four acid/buffer combinations having varying levels of buffer (0.1 wt % and 0.2 wt % based on the acidified candy mass), were tested in HM pectin gummy formulas containing active ingredients (per above process as outlined in Materials and Methods): malic acid/monosodium malate, malic acid/sodium citrate, citric acid/monosodium malate, citric acid/sodium citrate. The active ingredients tested were ascorbic acid and a B Vitamin Blend, and amounts are as shown in FIG. 2, where all percentages are wt % based on the acidified candy mass.

The monosodium malate-containing formulas were shown to hold pH more stable than sodium citrate formulas, even in the presence of destabilizing active agent ingredients.

Sensory Review of Pectin Gummies Containing Actives:

A gummy sensory evaluation was conducted with the above-noted ascorbic acid-containing gummies having 0.1 wt % buffer present. The Malic/Malate and Malic/Citrate Acid/Buffer combination performed the best and equally well in the sensory evaluation, and no off-notes were observed. The Citric/Citrate Acid/Buffer combination performed the worst, having a mild off-note with lingering at the end.

A further gummy sensory evaluation was conducted with the above-noted B Vitamin blend-containing gummies having 0.1 wt % buffer present. The Malic/Malate Acid/Buffer combination performed the best and resulted in a satisfactory gummy product, whereas the Citric/Citrate Acid/Buffer combination performed the worst, having a pronounced vitamin taste, strong linger, and chaotic flavor.

### Example 3—Monosodium Malate-Containing Gummy Compositions of HM Pectin have Acceptable Flavour Profiles

In the present experiment, sensory—flavor differences were observed for each of the 4 acid/buffer combinations (malic acid/monosodium malate, malic acid/sodium citrate, citric acid/monosodium malate, citric acid/sodium citrate) when used in pectin gummies. Four pectin gummy formulas were prepared (1. 0.6% citric acid/0.1% sodium citrate; 2. 0.6% citric acid/0.1% monosodium malate; 3. 0.6% malic acid/0.1% sodium citrate; 4. 0.6% malic acid/0.1% monosodium malate—all percentages are wt % based on the acidified candy mass).

The gummies were then sent out to −20 panelists to evaluate 7 different sour descriptors on a hedonic scale. The test was a blind test—the various formulas were labeled with a randomized code. The purpose of the experiment was to showcase how the sour experience differs with each combination.

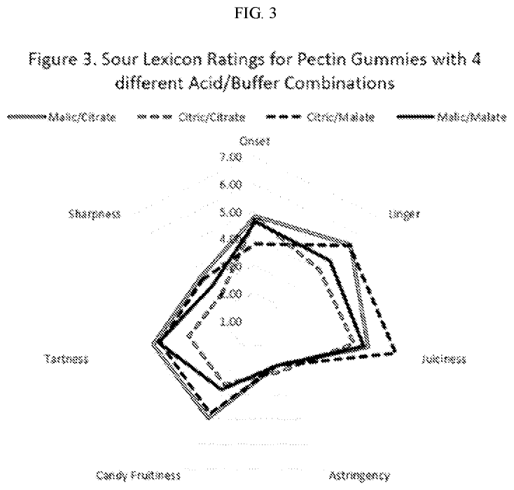

FIG. 3 illustrates the results. Gummy formulations with monosodium malate can help achieve specific sour profiles better or on par with sodium citrate gummies. For instance, gummies with citric acid and monosodium malate showed a quicker onset of flavor than the other 3 acid/buffer combinations. This could be useful for flavor masking, for example if the unappealing flavor within the gummy (e.g. from vitamins, medications, etc.) has an early onset. For linger, a citric acid/monosodium malate gummy performed similarly to a malic acid/sodium citrate gummy. So if a longer linger period is desired (for example, to mask a lingering taste from an active ingredient or high intensity sweetener), the citric acid/monosodium malate gummy performed just as well as the malic acid/sodium citrate gummy, with the monosodium malate formula demonstrating the added benefit of better pH control (per Examples 1, 2, and 4). If a high juiciness is desired for a formulation (e.g. desirable for fruit flavors), a citric acid/monosodium malate gummy showed superior performance to the other 3 acid/buffer combinations. For astringency, the monosodium malate formulations performed similarly to the sodium citrate formulations, and still offered the added benefit of better pH control (per Examples 1, 2, and 4). For candy fruitiness, monosodium malate was capable of demonstrating both high and low values, which means the formulator can achieve either taste profile with monosodium malate by choosing which acid to pair with it. For tartness, monosodium malate was capable of achieving high levels, whereas the current most typical buffer/acid pairing (sodium citrate/citric acid) was not capable of meeting that desired taste profile.

It was further observed that a pectin gummy made with a low level of monosodium malate and citric acid produces a very mild pectin gummy (0.375% citric acid, 0.05% monosodium malate). It is noted that this is very rare for HM pectin gummies, as normally there is a dominant acidic note (due to the fact that pectin is set by acid, and it is therefore hard to avoid the flavor of acidity). The gummy compositions prepared by the methods outlined herein are therefore expected to be particularly useful for masking ingredients having an off-note that is intensified by acid, and/or for preparing HM pectin-based gummies having a variety of flavours outside the typical fruit flavours (e.g. birthday cake).

### Example 4—Monosodium Malate Holds Gummy Composition pH within HM Pectin Setting Range (pH 3.2-3.6) Over a Range of Acid Amounts

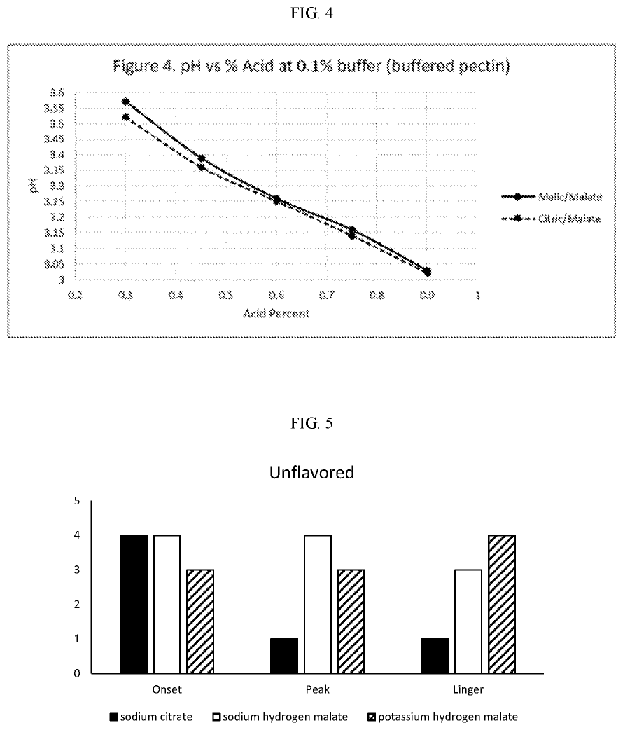

FIG. 4 shows a chart illustrating pH versus wt % acid at 0.1 wt % buffering agent. All percentages are wt % based on the acidified candy mass. At the lowest acid level (0.3% wt %), monosodium malate formulas hold pH within the ideal pectin setting pH range (3.2-3.6). Even when the acid level is more than doubled, the pH of the acidified candy mass remains within this optimal pH range with the same amount of buffer present. These results demonstrate that monosodium malate has significant pH control over a range of acid amounts.

### Example 5—Measurements of Unflavored Gummies

Unflavored pectin gummies were prepared having different buffers. The unflavored pectin gummies were all made with 0.6% malic acid by weight and either 0.2% sodium citrate by weight, 0.2% monosodium malate by weight, or 0.2% monopotassium malate by weight.

The peak (intensity of maximum sourness), onset (the time until maximum sourness is experienced), and linger (sourness following removal of a sample from the mouth) were measured by a 3 person sensory panel for each type of unflavored pectin gummy.

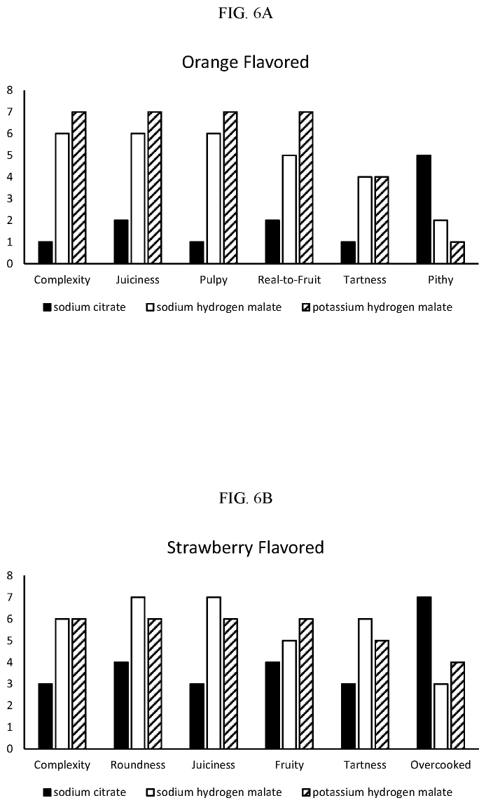

The results are shown in FIG. 5. As can be seen, the monosodium malate and monopotassium malate were able to augment the sourness profile of the gummy composition. Gummies having partially hydrogenated malic acid salts in combination with a food grade acid were able to increase the sour peak and provide an increased lingering sourness as compared to sodium citrate.

### Example 6—Measurements of Fruit Flavored Gummies

Three flavors of pectin gummy were made with equal levels of flavor, buffer, and acid. For each flavor, 3 different buffers were tested: Sodium Citrate, Sodium Malate, Potassium Malate and flavors were prepared with either malic acid or citric acid. The components of each pH stabilizing agent in the fruit flavored gummy are provided in Table 3.

TABLE 3

| | | Weight Percent | Weight Percent |
|---|---|---|---|
| | | of Food-safe acid | of Buffer |
| Flavor | Food-safe acid | (%) | (%) |
| Orange | Citric Acid | 0.6 | 0.2 |
| Strawberry | Malic Acid | 0.6 | 0.2 |
| Mixed Berry | Malic Acid | 1.0 | 0.5 |

A sensory evaluation for each gummy was performed by three expert reviewers. Six key flavor terms were identified for each flavor and ranked on a scale of 1-9. Table 4 provides the terms used to measure the strawberry and mixed berry flavors. Table 5 provides the terms used for the orange flavors.

TABLE 4

| Flavor | | | | | | |
|---|---|---|---|---|---|---|
| Descriptor | Complexity | Roundness | Juiciness | Fruity | Tartness | Overcooked |
| Explanation | How | How rounded | How much the | How close | How tart | How sweet |
| of the | complex is | is the overall | mouth is the | the flavor | the flavor | is the |
| parameter | the flavor? | experience of | watering after | represents | comes out | gummy |
| | | the eating | eating has begun | the fruit | | |
| Scale | 1 to 9 | 1 to 9 | 1 to 9 | 1 to 9 | 1 to 9 | 1 to 9 |
| Interpretation | 1 = Flat | 1 = Spiky | 1 = Dry | 1 = Artificial | 1 = Weak | 1 = Mildly |
| | 9 = Complex | 9 = Rounded | 9 = Juicy | 9 = Fruity | 9 = Strong | sweet |
| | | | | | | 9 = Excessively |
| | | | | | | sweet, mutes the |
| | | | | | | flavor |

TABLE 5

| Parameter | Complexity | Juiciness | Pulpy | Real-to-fruit | Tartness | Pithy |
|---|---|---|---|---|---|---|
| Explanation | How | How much | How close the | How close | How tart the | Pertaining |
| of the | complex is | the mouth is | eating experience | the flavor | flavor comes | to the |
| parameter | the flavor? | the watering | is close to the | represents | out | seed/zest/ |
| | | after eating | pulp of the | the fruit | | seed-like |
| | | has begun | fruit. | | | |
| Scale | 1 to 9 | 1 to 9 | 1 to 9 | 1 to 9 | 1 to 9 | 1 to 9 |
| Interpretation | 1 = Flat, | 1 = Dry | 1 = Sapless | 1 = Artificial | 1 = Weak | 1 = Fruity |
| | 9 = Complex | 9 = Juicy | 9 = Fleshly | 9 = Real fruit | 9 = Strong | 9 = Bitter |
| | | | | | | rind/seed- |
| | | | | | | like |

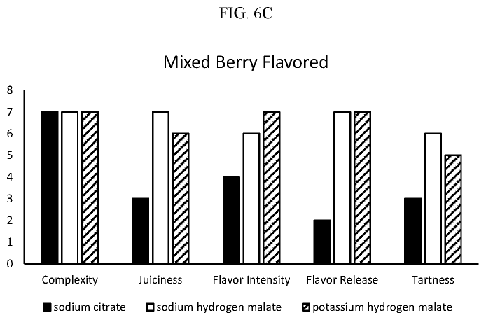

The results from the sensory panel evaluation are shown in FIG. 6A (orange), 6B3 (strawberry), and 6C (mixed berry).

Monosodium malate and monopotassium malate based gummies show a distinct difference in flavor profile when compared to Sodium Citrate gummies. For example, the strawberry gummy with citrate was less complex than the monosodium malate and monopotassium malate gummies. He monopotassium malate gummy was nicely rounded and flavorful and the monopotassium malate gummy is very jammy.

For the orange gummies, each gummy tasted as if an entirely different orange flavor was used. As can be seen in FIG. 6A, monopotassium malate nearly consistently had increased flavor descriptors even as compared to monosodium malate. The citrate orange gummy initially had the strongest rind taste, but became flat and pithy. The monosodium hydrogen malate gummy had less of this rind taste, but an orange-soda type flavor profile. The monopotassium malate gummy had a slight vitamin type tape, but, with aging, became the gummy which most resembled a real orange fruit.

### SPECIFIC EMBODIMENTS

Non-limiting specific embodiments (SEs) are described below each of which is considered to be within the present disclosure.

SE 1. A pH-stabilizing agent for a high-methoxyl pectin-based gummy composition, wherein the pH-stabilizing agent comprises:

a buffering agent comprising monosodium malate, monopotassium malate, or a mixture thereof; and
a food-safe acid.

SE 2. The pH-stabilizing agent of SE 1, wherein the buffering agent comprises monosodium malate.

SE 3. The pH-stabilizing agent of SE 1 or 2, wherein the buffering agent consists essentially of, or consists of, monosodium malate.

SE 4. The pH-stabilizing agent of any one of SEs 1-3, wherein the food-safe acid is selected from citric acid, malic acid, lactic acid, tartaric acid, or mixtures thereof.

SE 5. The pH-stabilizing agent of any one of SEs 1-4, wherein the food-safe acid is selected from citric acid, malic acid, or mixtures thereof.

SE 6. The pH-stabilizing agent of any one of SEs 1-5, wherein the high-methoxyl pectin-based gummy composition comprises high-methoxyl pectin having a degree of esterification of from 58% to 62%.

SE 7. The pH-stabilizing agent of any one of SEs 1-6, wherein the high-methoxyl pectin-based gummy composition does not comprise gelatin or other gelling agents other than the high-methoxyl pectin.

SE 8. The pH-stabilizing agent of any one of SEs 1-7, wherein the high-methoxyl pectin-based gummy composition comprises sucrose and a syrup selected from corn syrup, tapioca syrup, or a combination thereof.

SE 9. The pH-stabilizing agent of SE 8, wherein the syrup is corn syrup.

SE 10. The pH-stabilizing agent of any one of SEs 1-9, wherein the high-methoxyl pectin-based gummy composition further comprises an active agent.

SE 11. The pH-stabilizing agent of SE 10, wherein the active agent is selected from a nutraceutical agent or a pharmaceutical agent.

SE 12. The pH-stabilizing agent of SE 11, wherein the active agent comprises a vitamin or a vitamin blend.

SE 13. The pH-stabilizing agent of SE 12, wherein the high-methoxyl pectin-based gummy composition further comprises a flavoring agent and/or a coloring agent.

SE 14. The pH-stabilizing agent of any one of SEs 1-13, wherein the high-methoxyl pectin-based gummy composition comprises the buffering agent in an amount of from 0.05 wt % to 0.4 wt %, and the food-safe acid in an amount of from 0.3 wt % to 0.7 wt %; optionally, wherein the high-methoxyl pectin-based gummy composition comprises: high-methoxyl pectin in an amount of from 1.0 to 2.5 wt %, sucrose in an amount of from 20 wt % to 40 wt %, syrup in an amount of from 30 wt % to 50 wt %, and water in an amount of from 20 wt % to 30 wt %.

SE 15. Use of a buffering agent comprising monosodium malate, monopotassium malate, or a mixture thereof, in combination with a food-safe acid as a pH-stabilizing agent for a high-methoxyl pectin-based gummy composition.

SE 16. The use of SE 15, wherein the buffering agent comprises monosodium malate.

SE 17. The use of SE 15 or 16, wherein the buffering agent consists essentially of, or consists of, monosodium malate.

SE 18. The use of any one of SEs 15-17, wherein the food-safe acid is selected from citric acid, malic acid, lactic acid, tartaric acid, or mixtures thereof.

SE 19. The use of any one of SEs 15-18, wherein the food-safe acid is selected from citric acid, malic acid, or mixtures thereof.

SE 20. The use of any one of SEs 15-19, wherein the high-methoxyl pectin-based gummy composition comprises high-methoxyl pectin having a degree of esterification of from 58% to 62%.

SE 21. The use of any one of SEs 15-20, wherein the high-methoxyl pectin-based gummy composition does not comprise gelatin or other gelling agents other than the high-methoxyl pectin.

SE 22. The use of any one of SEs 15-21, wherein the high-methoxyl pectin-based gummy composition comprises sucrose and a syrup selected from corn syrup, tapioca syrup, or a combination thereof.

SE 23. The use of SE 22, wherein the syrup is corn syrup.

SE 24. The use of any one of SEs 15-23, wherein the high-methoxyl pectin-based gummy composition further comprises an active agent.

SE 25. The use of SE 24, wherein the active agent is selected from a nutraceutical agent or a pharmaceutical agent.

SE 26. The use of SE 25, wherein the active agent comprises a vitamin or a vitamin blend.

SE 27. The use of SE 26, wherein the high-methoxyl pectin-based gummy composition further comprises a flavoring agent and/or a coloring agent.

SE 28. The use of any one of SEs 15-27, wherein the high-methoxyl pectin-based gummy composition comprises the buffering agent in an amount of from 0.05 wt % to 0.4 wt %, and the food-safe acid in an amount of from 0.3 wt % to 0.7 wt %;

optionally, wherein the high-methoxyl pectin-based gummy composition comprises:
high-methoxyl pectin in an amount of from 1.0 to 2.5 wt %, sucrose in an amount of from 20 wt % to 40 wt %, syrup in an amount of from 30 wt % to 50 wt %, and water in an amount of from 20 wt % to 30 wt %.

SE 29. A method of preparing a gummy composition comprising:
(a) combining:
   a gelling agent comprising high-methoxyl pectin,
   a sweetening agent,
   water, and
a buffering agent comprising monosodium malate, monopotassium malate, or a mixture thereof; under mixing and heating conditions to form a pre-molding candy mass;
(b) adding a food-safe acid to the pre-molding candy mass under mixing conditions to form an acidified candy mass; and
(c) allowing the acidified candy mass to set to form the gummy composition;
   wherein the acidified candy mass has a pH of from 3.2 to 3.6.

SE 30. The method of SE 29, wherein the sweetening agent comprises sucrose.

SE 31. The method of SE 29 or 30, wherein the pre-molding candy mass further comprises a second sweetening agent comprising a syrup selected from corn syrup, tapioca syrup, or a combination thereof.

SE 32. The method of SE 31, wherein the syrup is corn syrup.

SE 33. The method of any one of SEs 29-32, wherein the pre-molding candy mass has a Brix value of from 68 to 85, or of from 75 to 85.

SE 34. The method of any one of SEs 29-33, wherein the gelling agent consists essentially of, or consists of, high-methoxyl pectin.

SE 35. The method of any one of SEs 29-34, wherein the high-methoxyl pectin has a degree of esterification of from 58% to 62%.

SE 36. The method of any one of SEs 29-35, wherein the buffering agent comprises monosodium malate.

SE 37. The method of any one of SEs 29-36, wherein the buffering agent consists essentially of, or consists of, monosodium malate.

SE 38. The method of any one of SEs 29-37, wherein the food-safe acid is selected from citric acid, malic acid, lactic acid, tartaric acid, or mixtures thereof.

SE 39. The method of any one of SEs 29-38, wherein the food-safe acid is selected from citric acid, malic acid, or mixtures thereof.

SE 40. The method of any one of SEs 29-39, wherein the method further comprises adding an active agent to the pre-molding candy mass of step (a) prior to forming the acidified candy mass in step (b).

SE 41. The method of SE 40, wherein the active agent is selected from a nutraceutical agent or a pharmaceutical agent.

SE 42. The method of SE 41, wherein the active agent comprises a vitamin or a vitamin blend.

SE 43. The method of SE 42, wherein the method further comprises adding a flavoring agent and/or a coloring agent to the pre-molding candy mass of step (a) prior to forming the acidified candy mass in step (b).

SE 44. The method of any one of SEs 29-43, wherein the acidified candy mass comprises the buffering agent in an amount of from 0.05 wt % to 0.4 wt %, and the food-safe acid in an amount of from 0.3 wt % to 0.7 wt %;
optionally, wherein the acidified candy mass comprises:
   high-methoxyl pectin in an amount of from 1.0 to 2.5 wt %,
   sucrose in an amount of from 20 wt % to 40 wt %,
   syrup in an amount of from 30 wt % to 50 wt %, and
   water in an amount of from 20 wt % to 30 wt %.

SE 45. A composition (e.g., a comestible composition, a sour sensory composition) having:

a) a pH stabilizing agent comprising monopotassium malate and a food-safe acid (e.g., malic acid, citric acid); and
b) a gellant (e.g., pectin, gelatin).

SE 46. The composition according to SE 45, wherein said composition mimics a fruit (e.g., strawberry, orange, mixed berry) and has a different flavor profile as compared to an otherwise identical composition having a pH stabilizing agent comprising monosodium malate.

SE 47. The composition according to SE 46, wherein said different flavor profile includes one of:
1) an increased complexity;
2) an increased roundness;
3) an increased juiciness;
4) an increased fruitiness;
5) an increased flavor intensity;
6) a decreased tartness;
7) a decreased pithiness; and
8) a closer mimic to the taste of natural fruit and/or pulp;
   as compared to an otherwise identical composition comprising monosodium malate in place of the monopotassium malate.

SE 48. The composition according to SE 47, wherein the fruit is orange and the different flavor profile has:
an increased complexity;
an increased juiciness;
a decreased pithiness; and
   a closer mimic to the taste and pulp of an orange.

SE 49. The composition according to SE 48, wherein the food-safe acid is citric acid.

SE 50. The composition according to SE 47, wherein the fruit is strawberry, and the different flavor profile has:
an increased roundness;
an increased juiciness;
a decreased tartness; and
decreased pithiness.

SE 51. The composition according to SE 48, wherein the food-safe acid is malic acid.

SE 52. The composition according to SE 47, wherein the fruit is mixed berry, and the different flavor profile has:
an increased flavor intensity; and
a decreased tartness.
   wherein said gellant comprises pectin.

SE 53. The composition according to SE 52, wherein the food-safe acid is malic acid.

SE 54. The composition according to any one of SEs 45-53, wherein the weight ratio of the food-safe acid to the monopotassium malate is greater than 1.5:1 (e.g., 1.5:1 to 10:1, 1.5:1 to 5:1, 1.5:1 to 4:1, 2:1 to 3:1).

SE 55. The composition according to any one of SEs 45-54, wherein the composition comprises:
a) less than (or from 0.1% to) 2% food-safe acid by weight of the composition (e.g., from 0.1% to 1.5%, 0.5%-1.2%, 0.6%, 1%); and/or
b) less than (or from 0.1% to) 1% potassium malate by weight of the composition (e.g., 0.1%-0.8%, 0.2%-0.7%, 0.4%-0.7%, 0.5%, 0.2%).

SE 56. The composition according to any one of SEs 45-55, wherein the gellant comprises pectin (e.g., high-methoxyl pectic, high-methoxyl pectin having a degree of esterification of from 58% to 62%).

SE 57. The composition according to any one of SEs 45-56, wherein the composition comprises from 1-5% gellant by weight of the composition (e.g., 1-2.5%).

SE 58. A method of preparing a gummy composition comprising:
a) combining a gelling agent, water, monopotassium malate, and a food-safe acid (e.g., malic acid, citric acid) to form a candy mass; and
b) allowing the candy mass to set to form the gummy composition.

SE 59. The method according to SE 58, wherein the combining step comprises:

A1) combining the gelling agent, water, and monopotassium malate to form a pre-molded candy mass; and
A2) adding the food-safe acid to the pre-molded candy mass to form the candy mass.

60. The method according to SE 59, wherein the pre-molding candy mass has a Brix value of from 68 to 85 (e.g., from 75 to 85).

SE 61. The method according to any one of SEs 58-60, wherein said gummy composition mimics a fruit (e.g., strawberry, orange, mixed berry) and has a different flavor profile as compared to an otherwise identical composition having a pH stabilizing agent comprising monosodium malate.

SE 62. The method according to SE 61, wherein said different flavor profile includes one of:
1) an increased complexity;
2) an increased roundness;
3) an increased juiciness;
4) an increased fruitiness;
5) an increased flavor intensity;
6) a decreased tartness;
7) a decreased pithiness; and
8) a closer mimic to the taste of natural fruit and/or pulp;
   as compared to an otherwise identical composition comprising monosodium malate in place of the monopotassium malate.

SE 63. The method according to SE 61, wherein the fruit is orange and the different flavor profile has:
an increased complexity;
an increased juiciness;
a decreased pithiness; and
a closer mimic to the taste and pulp of an orange.

SE 64. The method according to SE 48, wherein the food-safe acid is citric acid.

SE 65. The method according to SE 61, wherein the fruit is strawberry, and the different flavor profile has:
an increased roundness;
an increased juiciness;
a decreased tartness; and
a decreased pithiness.

SE 66. The method according to SE 48, wherein the food-safe acid is malic acid.

SE 67. The method according to SE 61, wherein the fruit is mixed berry, and the different flavor profile has:
an increased flavor intensity; and
a decreased tartness.
   wherein said gellant comprises pectin.

SE 68. The method according to SE 52, wherein the food-safe acid is malic acid.

SE 69. The method according to any one of SEs 58-68, wherein the weight ratio of the food-safe acid to the monopotassium malate in the gummy composition is greater than 1.5:1 (e.g., 1.5:1 to 10:1, 1.5:1 to 5:1, 1.5:1 to 4:1, 2:1 to 3:1).

SE 70. The method according to any one of SEs 58-69, wherein the gummy composition comprises:
a) less than (or from 0.1% to) 2% food-safe acid by weight of the gummy composition (e.g., from 0.1% to 1.5%, 0.5%-1.2%, 0.6%, 1%); and/or
b) less than (or from 0.1% to) 1% potassium malate by weight of the gummy composition (e.g., 0.1%-0.8%, 0.2%-0.7%, 0.4%-0.7%, 0.5%, 0.2%).

SE 71. The method according to any one of SEs 58-70, wherein the gellant comprises pectin (e.g., high-methoxyl pectic, high-methoxyl pectin having a degree of esterification of from 58% to 62%).

SE 72. The method according to any one of SEs 58-71, wherein the composition comprises from 1-5% gellant by weight of the composition (e.g., 1%-2.5%).

SE 73. A sour sensory composition comprising monopotassium malate and/or monosodium malate and a food-safe acid (e.g., citric acid, malic acid) in a ratio of from 10:1 to 1:10 (e.g., from 5:1 to 1:5, 1.5:1 to 10:1, 1.5:1 to 5:1, 1.5:1 to 4:1, 2:1 to 3:1).

SE 74. The sour sensory composition according to SE 73, wherein said composition is in powder or granular form.

SE 75. The sour sensory composition according to SE 73 or 74, wherein said composition comprises intimate admixture of said food-safe acid and said monopotassium malate and/or monosodium malate.

SE 76. The sour sensory composition according to any one of SEs 73-75, wherein said composition has a median particle size of less than 200 microns.

SE 77. The sour sensory composition according to any one of SEs 73-76 wherein food-safe acid has a particle size of less than 200 microns.

SE 78. The sour sensory composition according to any one of SEs 73-77, wherein said monopotassium malate and/or monosodium malate has a particle size of less than 200 microns.

SE 79. The sour sensory composition according to any one of SEs 73-78, wherein the composition further comprises a sweetener.

SE 80. The sour sensory composition according to SE 79, wherein the sweetener is sucrose.

SE 81. A comestible composition comprising a fruit flavor, a monopotassium malate and/or monosodium malate and a food-safe acid.

SE 82. The comestible composition according to SE 81, wherein the comestible composition is a gummy.

SE 83. The comestible composition according to SE 81, wherein the comestible composition is a beverage.

SE 84. The comestible composition according to SE 81, wherein the comestible composition is a hard candy.

SE 85. The comestible composition according to SE 81, wherein the comestible composition is a chewable candy.

SE 86. The comestible composition according to SE 81, wherein the comestible composition is a taffy or taffy type confectionery.

SE 87. The comestible composition according to any one of SEs 81-86, wherein the monopotassium malate and/or monosodium malate and said food-safe acid are dispersed homogenously throughout at least a portion of said comestible composition.

SE 88. The comestible composition according to any one of SEs 81-87, wherein the monopotassium malate and/or monosodium malate and food-safe acid are coated onto an exterior surface of said comestible composition.

SE 89. The comestible composition according to any one of SEs 81-88, wherein the fruit flavor is a citrus flavor.

SE 90. The comestible composition according to SE 89, wherein the citrus flavor is selected from orange, tangerine, lemon, lime, and grapefruit.

SE 91. The comestible composition according to SE 89, wherein the citrus flavor is orange.

SE 92. The comestible composition according to any one of SEs 81-88, wherein the fruit flavor is strawberry.

SE 93. The comestible composition according to any one of SEs 81-88, wherein the fruit flavor is mixed berry.

SE 94. A comestible composition comprising an orange flavor and monopotassium malate and/or monosodium malate.

SE 95. The comestible composition according to SE 94, further comprising a food-safe acid.

SE 96. The comestible composition according to SE 95, wherein the food-safe acid is citric acid.

SE 97. The comestible composition according to SE 96, wherein the weight ratio of the citric acid to monopotassium malate and/or monosodium malate is from 10:1 to 1:10.

SE 98. The comestible composition according to SE 96, wherein the weight ratio of the citric acid to monopotassium malate and/or monosodium malate is 1.5:1 to 3.5:1 (e.g., from 2:1 to 3:1).

SE 99. The comestible composition according to any one of SEs 94-98, wherein the comestible composition comprises less than 1.5% citric acid by weight of the comestible composition.

SE 100. The comestible composition according to any one of SEs 94-98, wherein the comestible composition comprises less than from 0.5% to 1.1% (e.g., 0.6%, 1%) citric acid by weight of the comestible composition.

SE 101. The comestible composition according to any one of SEs 94-100, wherein the comestible composition comprises less than (or from 0.10% to) 0.6% monopotassium malate and/or monosodium malate by weight of the composition.

SE 102. The comestible composition according to any one of SEs 94-100, wherein the comestible composition comprises less than (or from 0.1% to) 0.3% monopotassium malate and/or monosodium malate by weight of the composition.

As various changes can be made in the above-described subject matter without departing from the scope and spirit of the present disclosure, it is intended that all subject matter contained in the above description, or defined in the appended claims, be interpreted as descriptive and illustrative of the present disclosure. Many modifications and variations of the present disclosure are possible in light of the above teachings. Accordingly, the present description is intended to embrace all such alternatives, modifications and variances which fall within the scope of the appended claims.

All documents cited or referenced herein and all documents cited or referenced in the herein cited documents, together with any manufacturer's instructions, descriptions, product specifications, and product sheets for any products mentioned herein or in any document incorporated by reference herein, are hereby incorporated by reference, and may be employed in the practice of the disclosure.

1. A composition having:
a) a pH stabilizing agent comprising monopotassium malate and a food-safe acid; and
b) a gellant.

2. The composition according to claim 1, wherein said composition mimics a fruit and has a different flavor profile as compared to an otherwise identical composition having a pH stabilizing agent comprising monosodium malate.

3. The composition according to claim 2, wherein said different flavor profile includes one of:
1) an increased complexity;
2) an increased roundness;
3) an increased juiciness;
4) an increased fruitiness;
5) an increased flavor intensity;
6) a decreased tartness;
7) a decreased pithiness; and
8) a closer mimic to the taste of natural fruit and/or pulp;
as compared to an otherwise identical composition comprising monosodium malate in place of the monopotassium malate.

4. The composition according to claim 1, wherein the composition comprises:
a) less than 2% food-safe acid by weight of the composition; and/or
b) less than 1% potassium malate by weight of the composition.

5. A sour sensory composition comprising monopotassium malate and a food-safe acid in a ratio of from 10:1 to 1:10.

6. The sour sensory composition according to claim 5, wherein said composition is in powder or granular form.

7. The sour sensory composition according to claim 6, wherein said composition comprises intimate admixture of said food-safe acid and said monopotassium malate.

8. The sour sensory composition according to claim 6, wherein said composition has a median particle size of less than 200 microns.

9. The sour sensory composition according to claim 6, wherein food-safe acid has a median particle size of less than 200 microns.

10. A comestible composition comprising a fruit flavor, a monopotassium malate and a food-safe acid.

11. The comestible composition according to claim 10, wherein the comestible composition is a gummy, beverage, hard candy, chewable candy, taffy or taffy type confectionery.

12. The comestible composition according to claim 10, wherein the monopotassium malate and said food-safe acid are dispersed homogenously throughout at least a portion of said comestible composition.

13. The comestible composition according to claim 10, wherein the fruit flavor is a citrus flavor, strawberry flavor, or berry flavor.

14. The comestible composition according to claim 13, wherein the citrus flavor is selected from orange, tangerine, lemon, lime, and grapefruit.

15. A comestible composition comprising an orange flavor and monopotassium malate.

16. The comestible composition according to claim 15, further comprising a food-safe acid.

17. The comestible composition according to claim 16, wherein the food-safe acid is citric acid.

18. The comestible composition according to claim 17, wherein the weight ratio of the citric acid to monopotassium malate is from 1.5:1 to 3.5:1.

19. The comestible composition according to claim 15, wherein the comestible composition comprises less than 1.5% citric acid by weight of the comestible composition.

20. The comestible composition according to claim 15, wherein the comestible composition comprises less than (or from 0.1% to) 0.6% monopotassium malate by weight of the composition.
